(19) United States
(12) Patent Application Publication
(10) Pub. No.: US 2017/0336914 A1
(43) Pub. Date: Nov. 23, 2017

(54) TERMINAL DEVICE WITH TOUCHSCREEN PANEL

(71) Applicant: FUJITSU LIMITED, Kawasaki-shi (JP)

(72) Inventor: Takashi OKUMURA, Kawasaki (JP)

(73) Assignee: FUJITSU LIMITED, Kawasaki-shi (JP)

(21) Appl. No.: 15/480,662

(22) Filed: Apr. 6, 2017

(30) Foreign Application Priority Data
May 23, 2016 (JP) 2016-102712

(51) Int. Cl. G06F 3/041; G06K 9/00

(52) U.S. Cl. CPC G06F 3/0418; G06K 9/00362

(57) ABSTRACT

A terminal device having a display provided with a touchscreen panel includes a memory and a processor coupled to the memory and configured to extract information indicative of a vector of an arm from a captured image, and to disable detection of a touch operation in an area of the display in response to determining, based on the extracted information indicative of the vector of the arm, that the arm comes closer to a bezel along a perimeter of the display than a predetermined distance from the bezel.

### CROSS-REFERENCE TO RELATED APPLICATIONS

The present application is based upon and claims the benefit of priority from the prior Japanese Patent Application No. 2016-102712 filed on May 23, 2016, with the Japanese Patent Office, the entire contents of which are incorporated herein by reference.

### FIELD

The disclosures herein relate to a terminal device and a recording medium having a program embodied therein for controlling a touchscreen panel.

### BACKGROUND

As illustrated in FIG. 1A, a terminal device 10 has a display 3 having hinges 14 attached to the bottom side thereof, which enable the angle θ of the display 3 to be maintained at a desired angle. The user may wish to change the angle θ of the display 3 from a vertical angle illustrated in FIG. 1A to a horizontal angle illustrated in FIG. 1B. In such a case, the user may move the display 3 by holding some portions (e.g., portions A₁ and A₂) of a bezel 17 having a frame shape at the perimeter of the display 3.

With the display 3 being configured to detect a touch operation, a user hand may accidentally touch a touchscreen panel 12 to cause the terminal device 10 to perform an unintended operation (which will hereinafter be referred to as an erroneous operation). A recent design trend of the display 3 favors a narrow-face bezel 17. With such a configuration, it is increasingly likely that a hand touches a portion B of the touchscreen panel 12 to cause an erroneous operation.

There is a technology that allows an area to be specified for disablement on a touchscreen panel, so that the function to respond to a touch event in this specified area is disabled when detectors disposed at multiple positions of the display unit detect touch events (Patent Document 1, for example).

With the technology disclosed in Patent Document 1, however, an erroneous operation responding to the detection of a touch event may be performed upon the detectors detecting touch events on the display unit before the function to respond to a touch event is disabled.

Further, the provision of detectors at the bezel may require the thickness of the bezel to be increased to accommodate the thickness of the detectors (e.g., sensors), which acts against the preference for a narrow-face bezel. Those detectors may be disposed on the rear face of the touchscreen panel. With such a configuration, embedding the detectors in the touchscreen panel causes the thickness of the touchscreen panel to be increased to accommodate the thickness of the detectors, which acts against the preference for a thinner touchscreen panel.

### RELATED-ART DOCUMENTS

### Patent Document

[Patent Document 1] Japanese Laid-open Patent Publication No. 2014-63366

### SUMMARY

According to an aspect of the embodiment, a terminal device having a display provided with a touchscreen panel includes a memory and a processor coupled to the memory and configured to extract information indicative of a vector of an arm from a captured image, and to disable detection of a touch operation in an area of the display in response to determining, based on the extracted information indicative of the vector of the arm, that the arm comes closer to a bezel along a perimeter of the display than a predetermined distance from the bezel.

The object and advantages of the embodiment will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIGS. 1A through 1C are drawings illustrating the entire configuration of a terminal device and the angle of a display according to an embodiment;

FIG. 2 is a block diagram illustrating an example of the hardware configuration of the terminal device according to the embodiment;

FIG. 3 is a block diagram illustrating an example of the functional configuration of the terminal device according to the embodiment;

FIG. 4 is a flowchart illustrating an example of the control of the touchscreen panel according to the embodiment;

FIGS. 5A and 5B are drawings illustrating the vectors of arms and the detection of an operation on a bezel according to the embodiment;

FIGS. 6A through 6D are drawings illustrating examples of disabled areas of the touchscreen panel according to the embodiment; and

FIG. 7 is a flowchart illustrating an example of the control of the touchscreen panel according to the embodiment.

### DESCRIPTION OF EMBODIMENTS

In the following, embodiments of the present invention will be described with reference to the accompanying drawings. In the specification and drawings, elements having substantially the same functions or configurations are referred to by the same numerals, and a duplicate description thereof will be omitted.

### [Configuration of Terminal Device and Angle of Display]

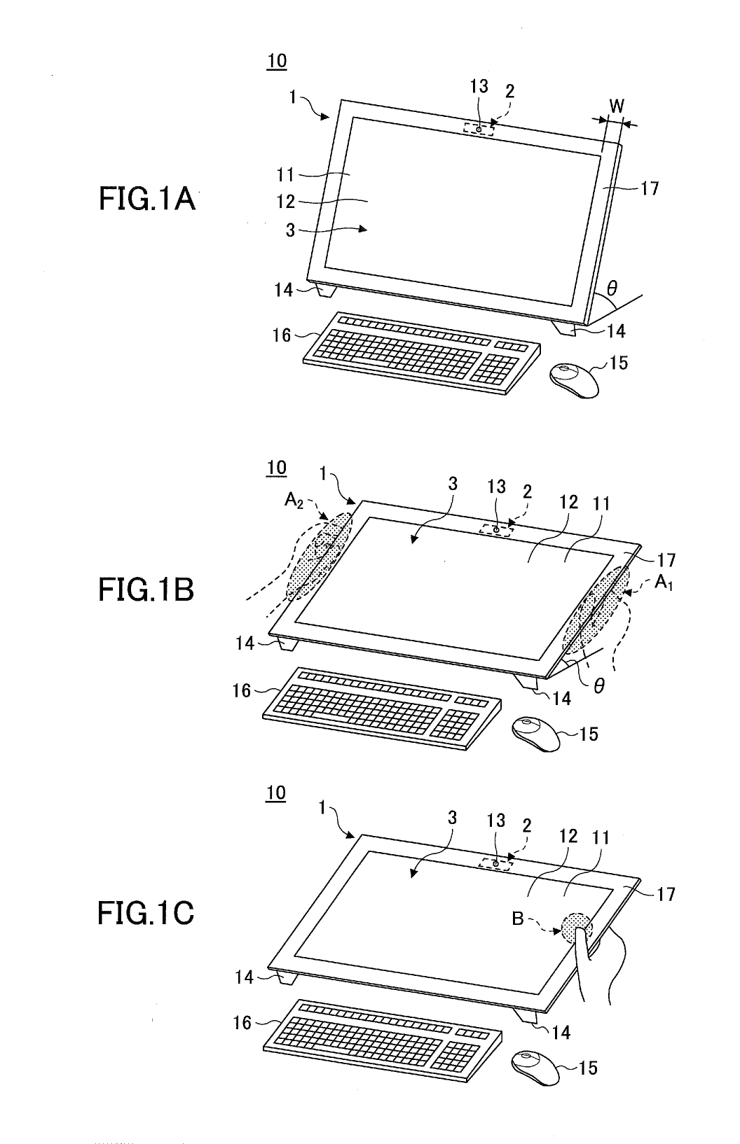

In the following, a description will be given of the configuration of the terminal device 10 and the angle of the display 3 according to an embodiment. As illustrated in FIG. 1A, the terminal device 10 of the embodiment includes a PC 1, a mouse 15, and a keyboard 16. The terminal device 10 is not limited to a personal computer (i.e., PC), but may be any electronic apparatus having the touchscreen panel 12 such as a tablet-type terminal or a gaming device.

The PC main body 1 is provided with the display 3 and the bezel 17 having a frame shape along the perimeter of the display 3. The bezel 17 has a camera controller 2 attached to the center of the upper side thereof. The camera controller 2 analyzes an image of the front view from the display 3 captured by a camera 13.

The display 3 includes a liquid crystal display panel 11 and the touchscreen panel 12 laminated thereon. The display 3 serves to display information and to detect a user's touch operation. The terminal device 10 operates in response to the detected touch operation.

The PC main body 1 has the hinges 14 attached to the bottom side thereof, which allow the angle θ of the display 3 to be maintained at a desired angle. The user may change the angle θ of the display 3 such that the display 3 is changed from the vertical position illustrated in FIG. 1A to the horizontal position illustrated in FIG. 1C. In such a case, the user may move the display 3 by holding the right-hand side and left-hand side of the bezel 17 of the bezel 17 (i.e., areas Aₗ and A₂ illustrated in FIG. 1B).

With the touchscreen panel 12 of the display 3 configured to detect a touch operation, the hand holding the bezel 17 and touching the touchscreen panel 12 (e.g., touching an area B illustrated in FIG. 1C) causes an erroneous operation. Especially with the recent design trend of the display 3 of the terminal device 10 which favors the bezel 17 having a narrow width W, it is increasingly likely for the hand holding the bezel 17 to touch the touchscreen panel 12.

In consideration of the above, the terminal device 10 of the present embodiment is configured to disable the function to respond to a touch event on the touchscreen panel 12 upon detecting based on images captured by the camera 13 that a user arm comes closer than a predetermined distance from the bezel 17. This arrangement prevents an erroneous operation from being performed when the hand holding the bezel 17 for changing the angle of the display 3 inadvertently touches the touchscreen panel 12.

### [Hardware Configuration]

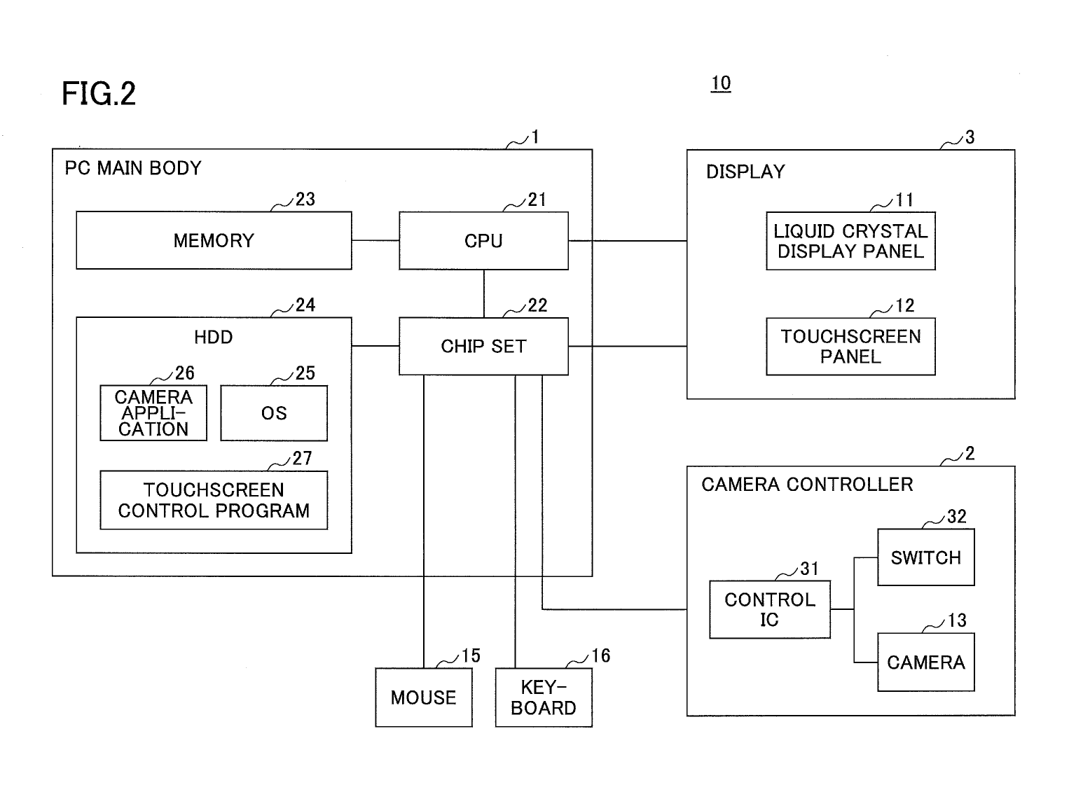

In the following, a description will be given of an example of the hardware configuration of the terminal device 10 according to the present embodiment by referring to FIG. 2. The PC main body 1 of the terminal device 10 includes a CPU (central processing unit) 21, a chip set 22, a memory 23, and a HDD (hard disk drive) 24.

The CPU 21 reads programs and data such as a touchscreen control program 27 from the HDD 24 through the chip set 22 to perform control processes and the like with respect to the touchscreen panel 12 and the like, thereby serving to provide the functions to perform comprehensive device control, the control of the touchscreen panel 12, etc.

The chip set 22 is coupled to the CPU 21, the HDD 24, the display 3, the camera controller 2, the mouse 15, and the keyboard 16. The chip set 22 has the function to control bus communications for the units connected thereto, thereby controlling data transmissions between these units.

The CPU 21 uses the chip set 22 to cause the camera 13 to capture an image after starting an OS 25 and activating a camera application 26. A control IC 31, which detects feature points indicative of fingers and elbows appearing in the image, analyses an arm vector extending from the elbow feature point to the finger feature point to produce information about the arm vector. A switch 32 serves to define a disabled area on the touchscreen panel 12. Operating the switch 32 allows the predetermined areas to be changed for which the detection of a touch event on the touchscreen panel 12 is disabled. The camera 13 may be two 3D cameras, or may be one camera. The Kinect may alternatively be provided in place of the camera 13.

### [Functional Configuration]

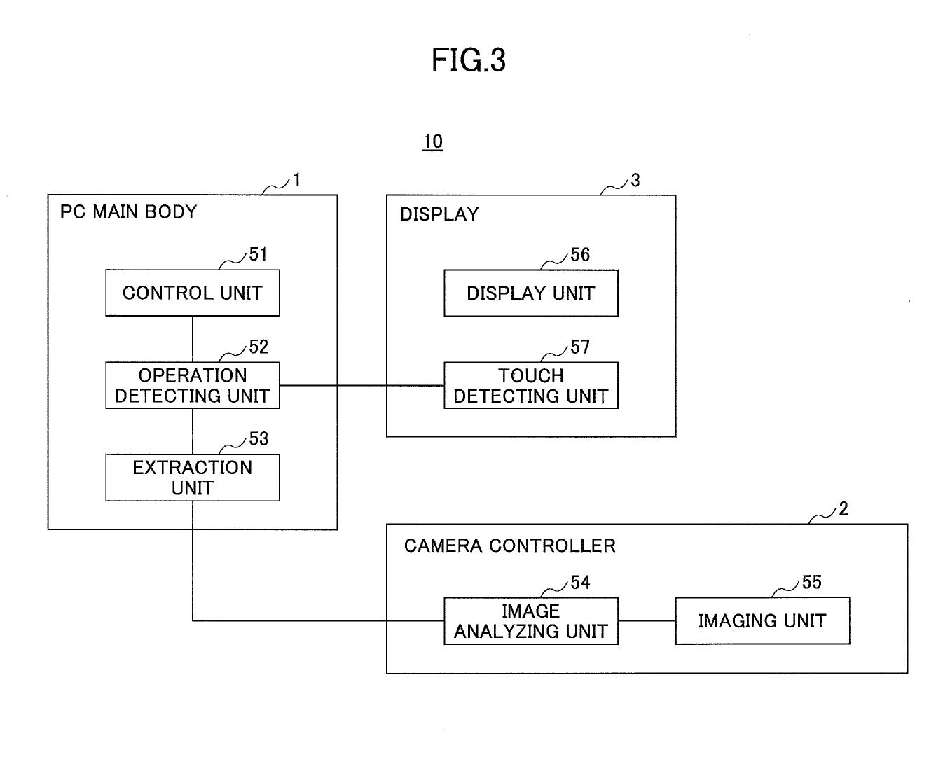

In the following, a description will be given of an example of the functional configuration of the terminal device 10 according to the present embodiment by referring to FIG. 3. The terminal device 10 includes a control unit 51, an operation detecting unit 52, an extraction unit 53, an image analyzing unit 54, an imaging unit 55, a display unit 56, and a touch detecting unit 57.

The imaging unit 55 captures an image of the front view from the display 3. The imaging function of the imaging unit 55 may be provided by the camera 13, for example. The image analyzing unit 54 detects feature points indicative of fingers and elbows by analyzing the image captured by the camera 13. The function of the image analyzing unit 54 may be implemented by use of the control IC 31, for example. The image analyzing unit 54 may also have the function to switch predetermined areas for which the detection of a touch event on the touchscreen panel 12 is disabled.

The display unit 56 displays predetermined information. The function of the display unit 56 may be provided by the liquid crystal display panel 11, for example. The touch detecting unit 57 detects a touch operation by a user's finger. The function of the touch detecting unit 57 may be provided by the touchscreen panel 12, for example.

The control unit 51 performs comprehensive control of the terminal device 10. The extraction unit 53 extracts information indicative of an arm vector connecting between the finger feature point and the elbow feature point extracted through image analysis by the image analyzing unit 54. Based on the information indicative of the extracted arm vector, the operation detecting unit 52 disables the detection of a touch operation in the predetermined area of the display 3 in the case of determining that the arm comes closer to the bezel 17 than a predetermined distance from the bezel 17.

The functions of the control unit 51, the operation detecting unit 52, and the extraction unit 53 may be implemented by use of the CPU 21, for example. Namely, these units are implemented as processes performed by the CPU 21 executing the touchscreen control program 27.

FIG. 3 illustrates a block diagram of the functions, which include functional blocks representing respective units, which may be implemented by use of hardware alone, software alone, or a combination of hardware and software.

### [Control of Touchscreen Panel]

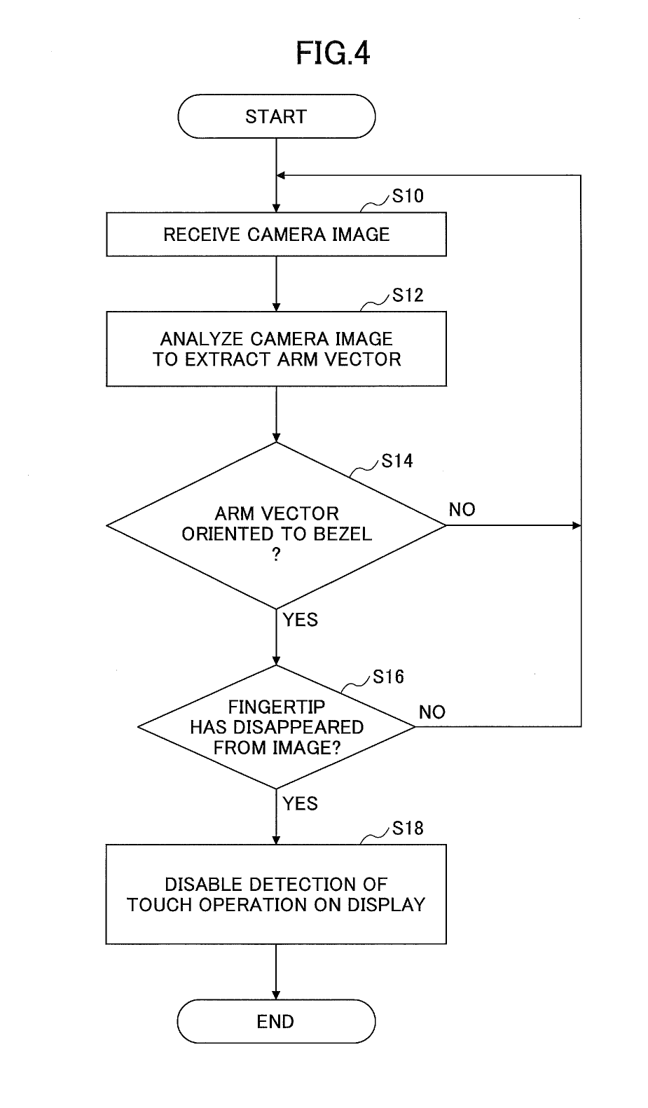

In the following, a description will be given of the control of the touchscreen panel according to the present embodiment by referring to FIG. 4. FIG. 4 is a flowchart illustrating the control of the touchscreen panel according to the present embodiment. Upon the start of the procedure of this flowchart, the image analyzing unit 54 receives an image captured by the camera 13 (step S10). The image analyzing unit 54 analyses the image captured by the camera 13 to detect feature points indicative of fingers and elbows, and the extraction unit 53 extracts information indicative of vectors connecting between the fingers and the elbows (step S12).

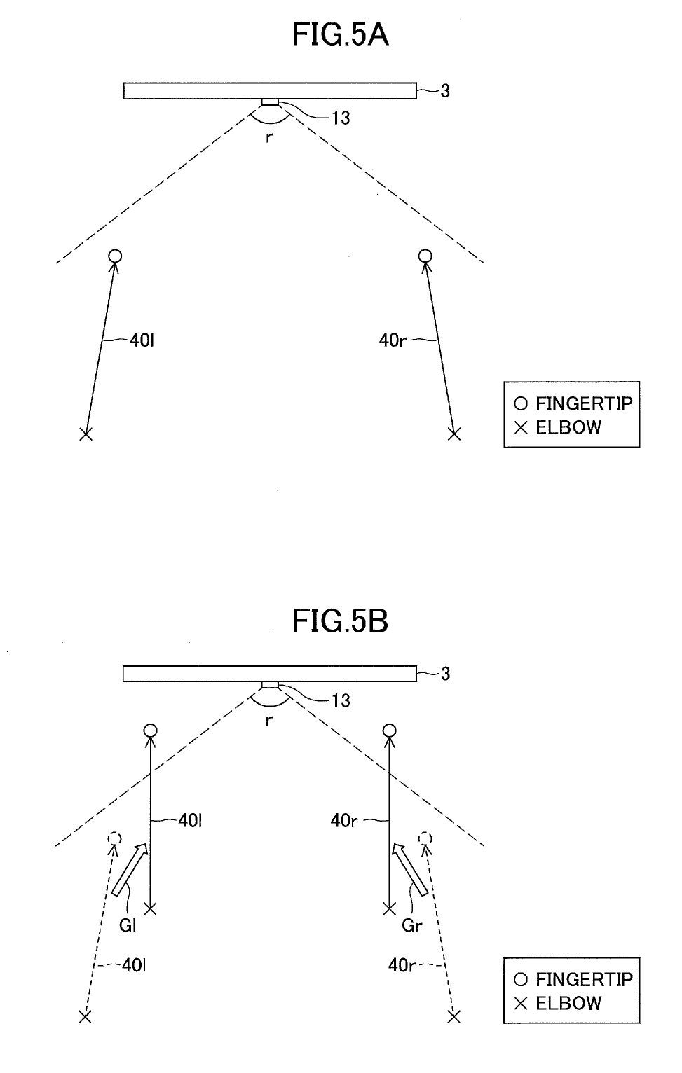

The operation detecting unit 52 checks whether an arm vector is oriented toward the bezel 17 based on the extracted information indicative of arm vectors (step S14). As illustrated in FIG. 5A, for example, the camera 13 captures an image of the front view from the display 3, which results in an image being taken with respect to an angle of view “r”. Analyzing the image produces feature points indicative of fingers and elbows, followed by the extraction of information indicative of a right-arm vector 40r and a left-arm vector 40l. Although the feature points indicative of fingers and elbows are detected in this example, fingers and elbows are not a limiting example. Any information regarding parts of arms such as wrists, palms, and/or the like may alternatively be detected and extracted.

By referring to FIG. 4 again, the procedure returns to step S10 when the operation detecting unit 52 detects that an arm vector is not oriented to the bezel 17. Upon the return, the image analyzing unit 54 receives a next camera image. When the operation detecting unit 52 detects that an arm vector is oriented to the bezel 17, the operation detecting unit 52 checks whether fingertips have disappeared from the image (step S16). In the state illustrated in FIG. 5A, the fingertips are situated within the angle of view “r” of the camera 13, which means that the fingertips have not disappeared from the image. In this case, the procedure returns to step S10, followed by receiving a next camera image.

Arm motion vectors Gr and Gl indicating that both of the user arms have made a transition from the state illustrated in FIG. 5A to the state illustrated in FIG. 5B may then be detected, with new arm vectors 40r and 40l being extracted. In this case, the fingertips which are no longer situated in the angle of view “r” of the camera 13 have disappeared from the image. In this case, the operation detecting unit 52 determines in step S16 that the fingertips have disappeared from the image, and disables in step S18 the detection of a touch operation in a predetermined area of the display 3. With this, the procedure comes to an end.

It may be noted that, in step S16, the operation detecting unit 52 may detect the disappearance of the fingertips of both hands, or may detect the disappearance of the fingertips of one hand.

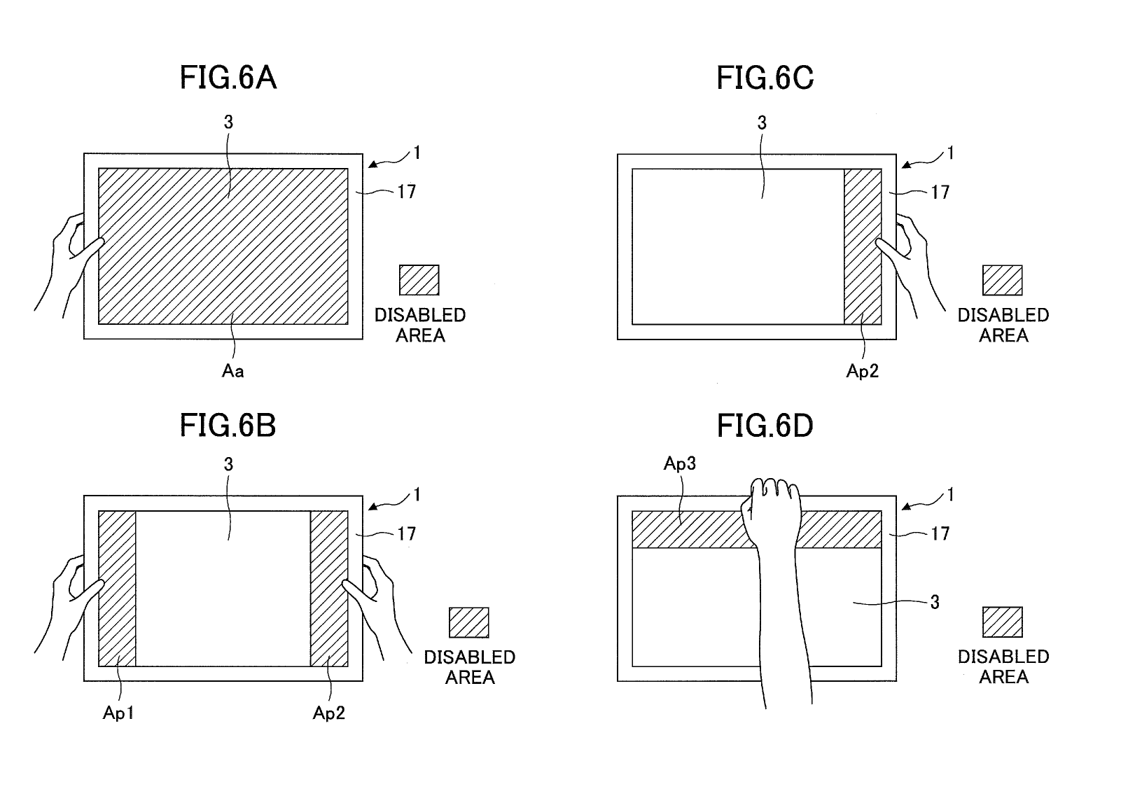

The area for which the detection of a touch operation is disabled may be the entire area Aa of the display 3 as illustrated in FIG. 6A. The area for which the detection of a touch operation is disabled may be areas Ap1 and Ap2 in the proximity of the left side and right side of the bezel 17 approached by the arms as illustrated in FIG. 6B when the approaching of both arms to the bezel 17 is detected. The area for which the detection of a touch operation is disabled may be only the area Ap2 in the proximity of the right side of the bezel 17 approached by an arm as illustrated in FIG. 6C when the approaching of this one arm to the bezel 17 is detected. The area for which the detection of a touch operation is disabled may be an area Ap3 in the proximity of the upper side of the bezel 17 approached by an arm as illustrated in FIG. 6D when the approaching of this one arm to the bezel 17 is detected.

Detecting an operation to change the angle of the display 3 may involve finding the condition that both arms approach the bezel 17. The use of such a condition in place of the condition that only one arm approaches the bezel 17 may be preferable from the viewpoint of achieving a fewer number of erroneous detections. This arrangement ensures that the detection of a touch event is disabled in a more reliable manner.

### [Enablement of Touchscreen Panel]

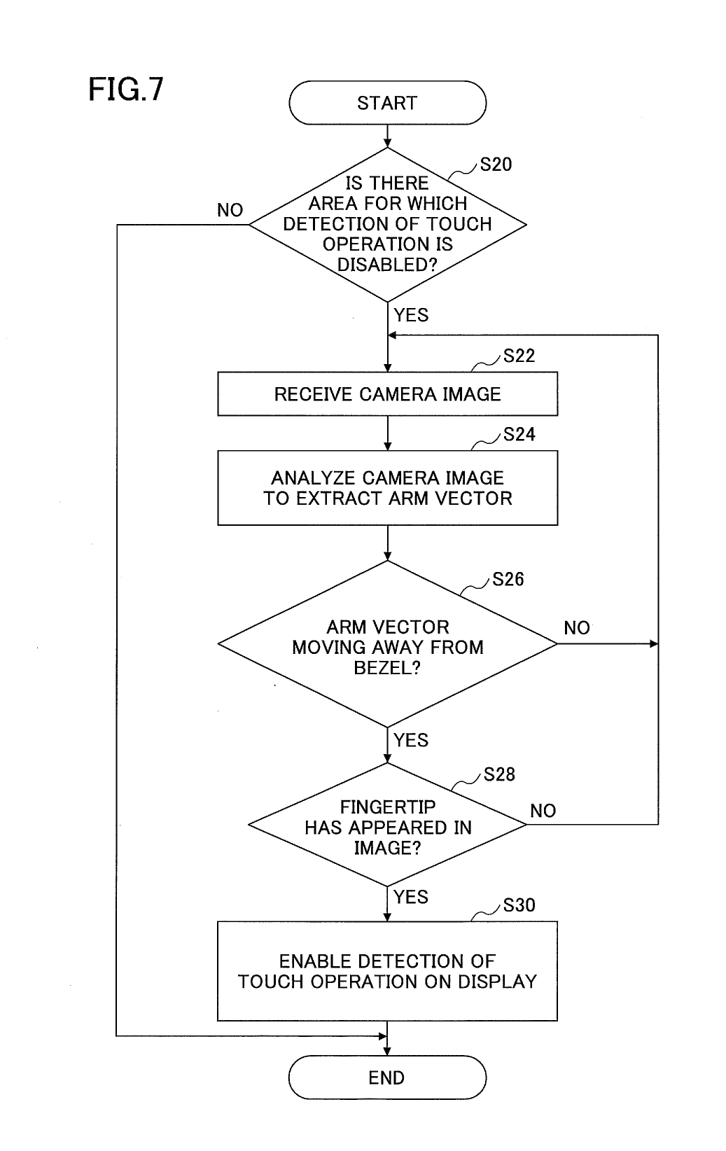

In the case of the detection of a touch operation having been disabled in FIG. 4, the area for which the detection of a touch operation has been disabled is enabled upon a certain set of conditions being satisfied. The control of the touchscreen panel according to the present embodiment for such an enablement process will be described by referring to FIG. 7.

Upon the start of the procedure of this flowchart, the operation detecting unit 52 checks whether an area for which the detection of a touch operation has been disabled is in existence (step S20). When the operation detecting unit 52 ascertains that there is no area for which the detection of a touch operation has been disabled, the procedure comes to an end. When the operation detecting unit 52 ascertains that there is an area for which the detection of a touch operation has been disabled, the procedure proceeds to step S22, in which the image analyzing unit 54 receives an image captured by the camera 13. The image analyzing unit 54 analyses the image captured by the camera 13 to detect feature points indicative of fingers and elbows, and the extraction unit 53 extracts information indicative of vectors connecting between the fingers and the elbows (step S24).

The operation detecting unit 52 checks whether an arm vector is moving away from the bezel 17 based on the extracted information indicative of arm vectors (step S26). The procedure returns to step S22 when the operation detecting unit 52 detects that an arm vector is not moving away from the bezel 17. Upon the return, the image analyzing unit 54 receives a next camera image.

When the operation detecting unit 52 detects that an arm vector is moving away from the bezel 17, the operation detecting unit 52 checks whether the fingertips have appeared in the image (step S28). Upon determining that the fingertips have not appeared in the image, the procedure returns to step S22, followed by the image analyzing unit 54 receiving a next camera image.

Upon determining that the fingertips have appeared in the image, the operation detecting unit 52 enables the detection of a touch operation in the disabled area (step S30). With this, the procedure comes to an end.

In the manner as described above, the control of the touchscreen panel performed by the terminal device 10 according to the present embodiment serves to prevent an erroneous operation from being performed when the angle of the display 3 is changed.

Further, the control of the touchscreen panel performed by the terminal device 10 according to the present embodiment serves to enable the detection of a touch operation smoothly after changing the angle of the display 3.

It may be noted that, in step S28, the operation detecting unit 52 may detect the appearance of the fingertips of both hands, or may detect the appearance of the fingertips of one hand. At the time of enablement, the detection of a touch operation may be enabled for the entire area Aa of the display 3 that has been disabled as illustrated in FIG. 6A. Alternatively, the detection of a touch operation may be enabled for the one or more specific areas near the bezel 17 that are situated in the proximity of both hands or one hand detected as having approached the bezel 17.

The control process illustrated in FIG. 7 may be performed in conjunction with the control process illustrated in FIG. 4 at the end of a predetermined time period following the end of the control process of FIG. 4, or may alternatively be performed at regular intervals independently of the control process of FIG. 4. The process in step S20 may be omitted when the control process illustrated in FIG. 7 is performed at the end of a predetermined time period following the control process of FIG. 4.

Although the terminal device and the control program for a touchscreen panel have heretofore been described with reference to the embodiment, the terminal device and the control program for a touchscreen panel of the present invention are not limited to such an embodiment, and various modifications and improvements may be made without departing from the scope of the invention. These embodiments and variations may be combined with each other as long as they do not contradict each other.

In step S14 of FIG. 4, for example, a check is made as to whether an arm vector is oriented to the bezel 17 along the perimeter of the display 3. It is reasonable to assume that at the time of changing the angle of the display 3, a user is more likely to hold the center of one or more sides of the bezel 17 than to hold one or more corners of the bezel 17. In consideration of this, step S14 of FIG. 4 may alternatively check whether an arm vector is oriented to one of the four sides of the bezel 17 excluding the corners.

The use of two 3-dimensional cameras capable of detecting distance allows a distance from the bezel 17 to a fingertip to be detected. In such a case, a distance-based check may be made in place of the checks performed in steps S14 and S16 of FIG. 4 for ascertaining whether the conditions required to disable the detection of a touch operation are satisfied, and may also be made in place of the checks performed in steps S26 and S28 of FIG. 7 for ascertaining whether the conditions required to enable the disabled area are satisfied.

In this manner, a check as to whether an arm has come closer to the bezel 17 than a predetermined distance may be made by using a distance directly measured by the camera 13, or may be made by analyzing images captured by the camera 13.

Further, a check based on camera images may be supplemented by the detection of a line of sight, which may be performed together with the checks in steps S14 and S16 of FIG. 4 for determining whether to disable the detection of a touch operation, and may also be performed together with the checks in steps S26 and S28 of FIG. 7 for determining whether to enable the detection of a touch operation. With this arrangement, a check as to whether a line of sight is directed to the bezel 17 may be made in addition to the check as to whether an arm is oriented to the bezel 17 and the check as to whether an arm is moving away from the bezel 17. This serves to improve the accuracy of checks, which allows the disabling and enabling of the detection of a touch operation to be controlled at proper timing, thereby reliably suppressing the occurrence of erroneous operations.

According to at least one aspect, an erroneous operation is prevented when the angle of the display is changed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present inventions have been described in detail, it should be understood that the various changes, substitutions, and alterations could be made hereto without departing from the spirit and scope of the invention.

What is claimed is:

1. A terminal device having a display provided with a touchscreen panel, comprising:
a memory; and
a processor coupled to the memory and configured to:
extract information indicative of a vector of an arm from a captured image; and
disable detection of a touch operation in an area of the display in response to determining, based on the extracted information indicative of the vector of the arm, that the arm comes closer to a bezel along a perimeter of the display than a predetermined distance from the bezel.

2. The terminal device as claimed in claim 1, wherein the extracted information indicates vectors of both arms, and the processor disables the detection of a touch operation in one or more areas of the display in response to determining, based on the extracted information indicative of the vectors of both arms, that both of the arms come closer to the bezel along the perimeter of the display than a predetermined distance from the bezel.

3. The terminal device as claimed in claim 1, wherein the processor disables the detection of a touch operation in an entire area of the display or in a particular area of the display, the particular area being in a proximity of a portion of the bezel, the portion of the bezel being approached by the arm.

4. The terminal device as claimed in claim 1, wherein the detection of a touch operation in the area of the display is enabled in response to determining, based on the extracted information indicative of the vector of the arm, that the arm moves further away than a predetermined distance from the bezel along the perimeter of the display.

5. A non-transitory computer-readable recording medium having a program stored therein for causing a computer to perform a process of controlling a terminal device having a display with a touchscreen panel, the process comprising:
a process to extract information indicative of a vector of an arm from a captured image; and
a process to disable detection of a touch operation in an area of the display in response to determining, based on the extracted information indicative of the vector of the arm, that the arm comes closer to a bezel along a perimeter of the display than a predetermined distance from the bezel.

6. The non-transitory computer-readable recording medium as claimed in claim 5, wherein the extracted information indicates vectors of both arms, and the process to disable the detection disables the detection of a touch operation in one or more areas of the display in response to determining, based on the extracted information indicative of the vectors of both arms, that both of the arms come closer to the bezel along the perimeter of the display than a predetermined distance from the bezel.

7. The non-transitory computer-readable recording medium as claimed in claim 5, wherein the process to disable the detection disables the detection of a touch operation in an entire area of the display or in a particular area of the display, the particular area being in a proximity of a portion of the bezel, the portion of the bezel being approached by the arm.

8. The non-transitory computer-readable recording medium as claimed in claim 5, wherein the detection of a touch operation in the area of the display is enabled in response to determining, based on the extracted information indicative of the vector of the arm, that the arm moves further away than a predetermined distance from the bezel along the perimeter of the display.
